(19) United States
(12) Patent Application Publication
(10) Pub. No.: US 2002/0085509 A1
(43) Pub. Date: Jul. 4, 2002

(54) Radio communication apparatus

(75) Inventors: Satoshi Funayama, Sagamihara-shi (JP); Toshihisa Yamamoto, Hachioji-shi (JP); Satoshi Komine, Hiki-gun (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/026,890

(22) Filed: Dec. 27, 2001

(30) Foreign Application Priority Data
Dec. 28, 2000 (JP) 2000-400829

(51) Int. Cl. H04B 1/56; H04L 5/14

(52) U.S. Cl. 370/276

(57) ABSTRACT

A phase varying circuit which varies the phase of the output load of a duplexer is provided between the duplexer and a receiving circuit. The phase varying circuit is controlled according to a frequency channel pair to be used, thereby changing the phase of the output load of the duplexer according to the frequency channel pair to be used.

### CROSS-REFERENCE TO RELATED APPLICATION

This application is based upon and claims the benefit of priority from prior Japanese Patent Application No. 2000-400829, filed Dec. 28, 2000, the entire contents of which are incorporated herein by reference.

### BACKGROUND OF THE INVENTION

1. Field of the Invention

This invention relates to a radio communication apparatus used for, for example, a base station or a mobile communication terminal in a mobile communication system.

2. Description of the Related Art

With the enhancement of mobile communication networks and the increasing needs of users for communication in recent years, mobile communication terminals, including mobile telephones and PDAs (personal digital assistants) have rapidly become popular. Some mobile communication terminals have used the FDD (Frequency Division Duplex) system as a two-way transmission system, causing a transmitting circuit and a receiving circuit to share a single antenna.

This type of terminal receives a radio signal transmitted from, for example, a base station by means of an antenna and thereafter inputs the signal via a duplexer to the receiving circuit. The receiving circuit amplifies the input radio signal with a low-noise amplifier, and then removes the unnecessary wave components outside the reception band with a high-frequency filter, and thereafter converts the resulting signal into an intermediate frequency signal with a frequency converter. Then, an intermediate frequency filter extracts the signal in the desired reception band from the intermediate frequency signal. An intermediate frequency amplifier amplifies the extracted signal in the desired band and inputs the resulting signal to an orthogonal demodulator. The orthogonal demodulator demodulates the input signal.

The factors that determine the receiving characteristic of the receiving circuit include fluctuations in the reception level of the radio signal, distortions occurring in the receiving circuit, and leakage of the transmitted signal into the receiving circuit. Of them, fluctuations in the reception level of the radio signal and distortions occurring in the receiving circuit can be suppressed by constructing the low-noise amplifier and intermediate amplifier out of automatic gain control (AGC) amplifiers.

On the other hand, the leakage of the transmitted signal into the receiving circuit is ascribed to insufficient attenuation in the transmission band at the reception band filter provided in the duplexer. If the level of leakage of the transmitted signal is great, the leaked transmitted wave components and disturbance wave components cause cross modulation in the low-noise amplifier, degrading the reception sensitivity.

For example, when the transmission band is set in a frequency band lower than the reception band, the amount of leakage into the receiving circuit becomes larger as the channel being used has a higher frequency among a plurality of frequency channels set in the transmission band. For this reason, when radio transmission is performed using a transmitting channel with a high frequency, the cross modulation has an effect on the receiving channel pairing with the transmitting channel, degrading the reception sensitivity of the receiving channel significantly. In contrast, when the transmission band is set in a frequency band higher than the reception band, the amount of leakage into the receiving circuit becomes larger as the channel being used has a lower frequency in the transmission band. For this reason, when radio transmission is performed using a transmitting channel with a low frequency, the cross modulation has an effect on the receiving channel pairing with the transmitting channel, degrading the reception sensitivity of the receiving channel significantly.

To overcome this problem, a method of increasing the selectivity of the receiving filter in the duplexer has been proposed. With this method, sufficient attenuation of the transmission band at the receiving filter of the duplexer can be secured, thereby decreasing the leakage of the transmitted wave into the reception band.

However, if the attenuation in the transmission band at the receiving filter of the duplexer is increased, the insertion loss in the reception band increases. This causes a problem: of a plurality of receiving channels set in the reception band, the reception sensitivity of the receiving channels on the side adjacent to the transmission band deteriorates.

### BRIEF SUMMARY OF THE INVENTION

The object of the present invention is to provide a radio communication apparatus which decreases the effect of the leakage of the transmitted wave into the frequency channel during reception, thereby keeping the reception sensitivity high whatever frequency channel in the reception band is used and enabling high-quality reception.

According to an aspect of the present invention, there is provided a radio communication apparatus comprising a duplexer which connects an antenna with a transmitting circuit and a receiving circuit in such a manner that the transmitting circuit and receiving circuit share the antenna and a phase varying circuit, which is provided between the duplexer and the receiving circuit and varies the phase of the output load of the duplexer. The radio communication apparatus further comprises a channel selecting circuit which selects a usable channel from a plurality of frequency channel pairs set in a transmission band and a reception band and a phase variation control circuit. The phase variation control circuit controls the phase varying circuit according to the selected frequency pair, thereby changing the phase of the output load of the duplexer to a value corresponding to the selected frequency channel pair.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a circuit block diagram showing a configuration of a CDMA mobile communication terminal unit according to a first embodiment of the present invention;

FIG. 2 is a block diagram showing the configuration of the receiving circuit and control section of the unit shown in FIG. 1;

FIG. 3 is a circuit block diagram showing the configuration of the phase shift circuit provided in the receiving circuit shown in FIG. 2;

FIG. 4 is a circuit configuration diagram of a phase shifter provided in the phase shift circuit of FIG. 3;

FIG. 5 shows a frequency characteristic of the reception gain of the receiving circuit shown in FIG. 2;

FIG. 6 is a block diagram showing the configuration of an impedance shift circuit provided in a CDMA mobile communication terminal unit according to a second embodiment of the present invention;

FIG. 7A and FIG. 7B are a circuit configuration diagram of the impedance shift circuit shown in FIG. 6;

FIG. 8 is a circuit configuration diagram of an impedance shift circuit provided in a CDMA mobile communication terminal unit according to a third embodiment of the present invention; and

FIG. 9 shows a frequency characteristic of the reception gain of a receiving circuit according to a fourth embodiment of the present invention.

### DETAILED DESCRIPTION OF THE INVENTION

(First Embodiment)

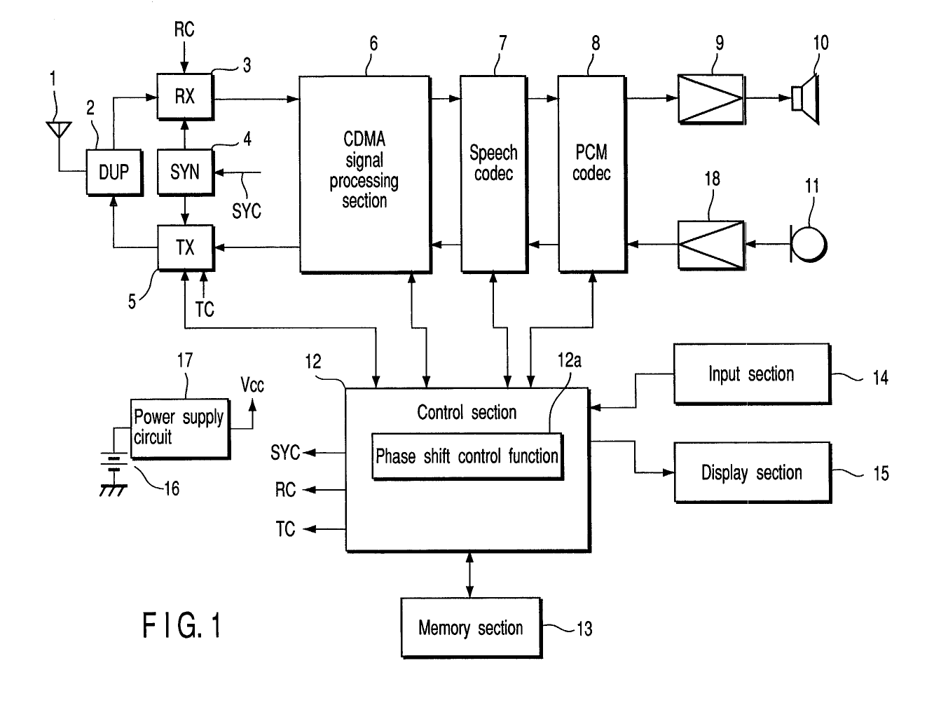

FIG. 1 is a block diagram showing the functional configuration of a CDMA (Code Division Multiple Access) mobile communication terminal according to a first embodiment of the present invention.

In FIG. 1, after the radio signal transmitted from a base station (not shown) is received by an antenna 1, it is input via a duplexer 2 (DUP) to a receiving circuit (PX) 3. In the receiving circuit 3, the radio signal is mixed with the receiving local oscillation signal output from a frequency synthesizer (SYN) 4 and thereby frequency-converted into an intermediate frequency signal. The intermediate frequency signal is further subjected to orthogonal demodulation. The frequency of the local oscillation signal generated at the frequency synthesizer 4 is specified by a control signal SYC from a control section 12.

A CDMA signal processing section 6 subjects the demodulated signal output from the receiving circuit 3 to despreading using spreading codes, thereby converting the demodulated signal into the demodulated data in a specific format according to the data rate. Then, the converted demodulated data is input to an audio coding and decoding section (hereinafter, referred to as an speech codec) 7. An information according to the data rate in the received data is input to the control section 12.

The speech codec 7 subjects the demodulated data output from the CDMA signal processing section 6 to an expansion process according to the received data rate specified by the control section 12. Then, the codec 7 subjects the expanded demodulated data to an audio decoding process using Viterbi decoding or the like and an error correction decoding process, thereby reproducing the received digital data.

A PCM coding and decoding section (hereinafter, referred to as a PCM codec) 8 carries out a signal process corresponding to the type of communication according to the control signal representing the type of communication (audio communication or data communication) output from the control section 12. That is, in audio communication, the received digital data output from the speech codec 7 is PCM-decoded, thereby output the analog received signal. The analog received signal is amplified by a receiver amplifier 9 and then output as sound from a speaker 10. In data communication, the received digital data output from the speech codec 7 is output to the control section 12. The control section 12 stores the received digital data in a memory section 13. As the need arises, the received digital data is output from an external interface (not shown) to a personal digital assistance (PDA) (not shown) or a notebook personal computer (not shown).

In contrast, the user's voice input to a microphone 11 during speech communication is amplified to the proper level by a transmitter amplifier 18. The PCM coding section 8 subjects the amplified transmitted signal to PCM coding, thereby producing transmitted audio data. The audio data is input to the speech codec 7. Text data output from a PDA (not shown) or a notebook personal computer (not shown) or image data output from a camera (not shown) is input via an external interface to the control section 12. The control section 12 inputs the input data to the speech codec 7.

In speech communication, the speech codec 7 senses the amount of energy in the input sound from the transmitted audio data supplied from the PCM codec 8 and determines the data rate on the basis of the result of the sensing. Then, the transmitted audio data is compressed into a burst signal in a format corresponding to the data rate. After the compressed signal is subjected to an error correction coding process, the resulting signal is output to the CDMA signal processing section 6. In data communication, the transmitted data, such as the input text data or image data, is compressed into a burst signal in the format corresponding to the preset data rate. After the compressed signal is subjected to the error correction process, the resulting signal is output to the CDMA signal processing section 6. The data rate in either audio communication or data communication is reported as the transmitted data rate to the control section 12.

The CDMA signal processing section 6 subjects the burst signal output from the speech codec 7 to a spreading process using spreading codes. Then, the section 6 subjects the spreading-coded transmitted signal to an orthogonal modulation process and supplies the orthogonal modulation signal to a transmitting circuit (TX) 5.

The transmitting circuit 5 combines the orthogonal modulation signal with the transmitting local oscillation signal generated by the frequency synthesizer 4, thereby converting the orthogonal modulation signal into a radio signal. Then, on the basis of the transmitting data rate specified by the control section 12, the transmitting circuit 5 high-frequency-amplifies only the effective part of the radio signal and outputs the amplified signal as a transmitted radio signal. The transmitted radio signal output from the transmitting circuit 5 is supplied via the duplexer 2 to the antenna 1. The radio signal is transmitted from the antenna 1 to a base station (not shown).

An input section 14 is provided with a key group including a dial key, a send key, a power ON/OFF key, an end key, a volume control key, and a mode key. A display section 15 is provided with an LCD and an LED. On the LCD, the telephone number of the called user, the operating state of the present terminal, the transmitted data, the received data, and other information are displayed. The LCD also displays information about the remaining capacity of a battery 16. The LED is used to display the charged state of the battery 16. It is also used to inform the user of an incoming call. Numeral 17 indicates a power supply circuit, which produces a specific operating power supply voltage according to the output of the battery 16 and supplies the voltage to each circuit section.

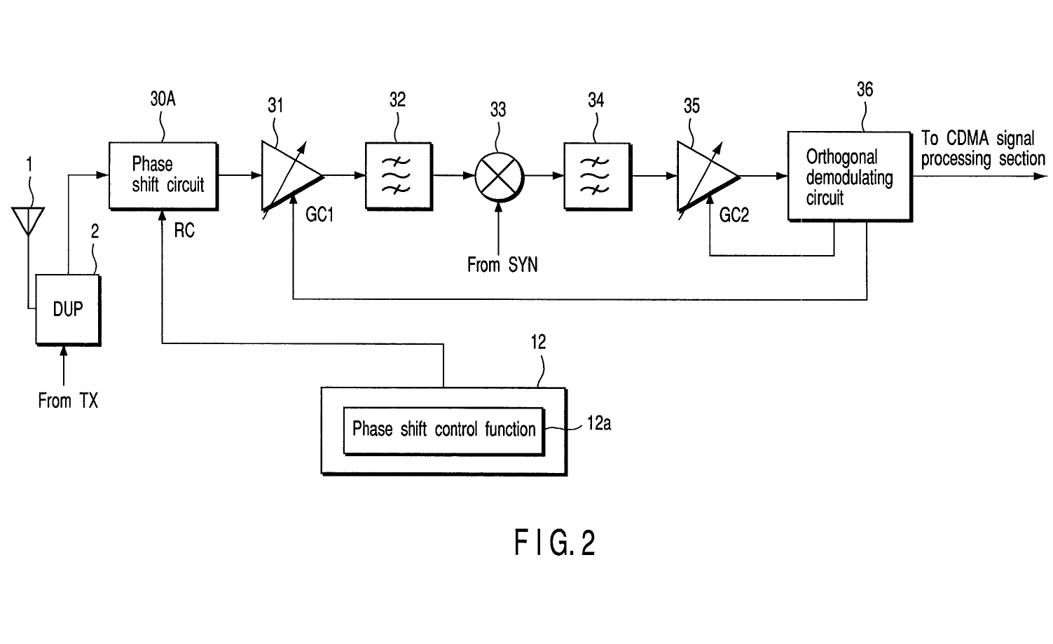

The receiving circuit 3 and control circuit 12 are constructed as described below. FIG. 2 is a circuit block diagram showing their circuit configuration and functional configuration.

The radio signal received by the antenna 1 is input via the duplexer 2 and a phase shift circuit 30A to a low-noise amplifier (LNA) 31, which subjects the radio signal to high-frequency amplification. Then, after a high-frequency filter (RF filter) 32 removes the unnecessary wave components outside the reception band from the amplified radio signal, a frequency conversion mixer (MIX) 33 mixes the resulting radio signal with the receiving local oscillation signal supplied from the frequency synthesizer 4, thereby converting the radio signal into an intermediate frequency signal.

Then, the converted intermediate frequency signal is input to an intermediate frequency filter (IF filter) 34, which extracts the desired reception band signal. An intermediate frequency amplifier 35 adjusts the extracted desired reception band signal so that the signal level may be constant and inputs the adjusted signal to an orthogonal demodulating circuit 36, which subjects the input signal to orthogonal demodulation.

The orthogonal demodulating circuit 36 also generates a first and a second gain control signal GC1, GC2 according to the quality of the demodulated signal. These gain control signals GC1, GC2 are supplied to the low-noise amplifier 31 and intermediate frequency amplifier 35, respectively. The low-noise amplifier 31 and intermediate frequency amplifier 35 are composed of AGC amplifiers and adjust the signal level of the radio signal and intermediate frequency signal according to the gain control signals GC1, GC2, respectively.

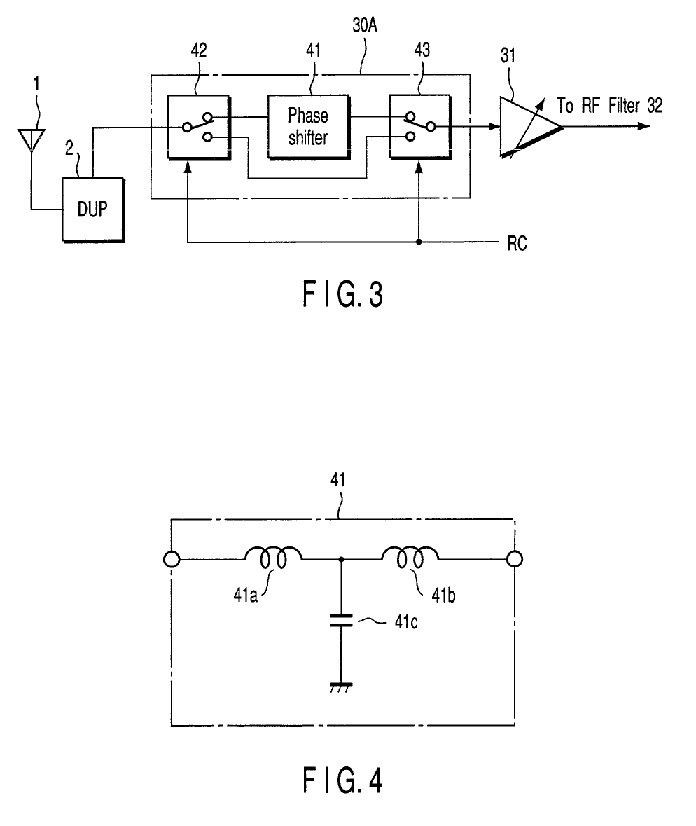

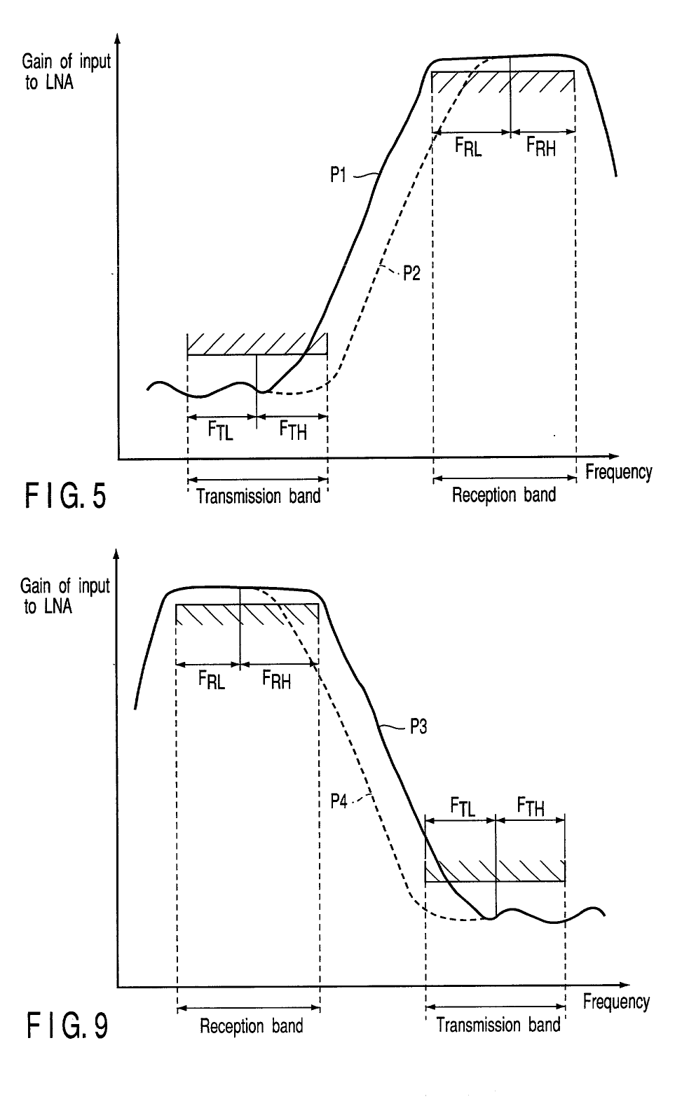

FIG. 3 shows the configuration of the phase shift circuit 30A. The phase shift circuit 30A, which is for shifting the phase of the output load of the duplexer to a specific value, comprises a phase shifter 41 and switching circuits 42, 43 placed at both ends of the phase shifter 41. The phase shifter 41 is composed of a filter circuit made up of, for example, inductors 41a, 41b and a capacitor 41c connected in the shape of T as shown in FIG. 4. The characteristic of the filter circuit is such that the phase of the output load of the receiving filter provided in the duplexer 2 can be attenuated sufficiently throughout the transmission band as shown by P2 in FIG. 5.

The control section 12 has a microprocessor, a memory that stores programs the microprocessor executes, and an input/output interface. The memory stores not only a program that realizes primary control functions, including radio channel selection control and data transmission/reception control, but also a program that realizes a phase shift control function 12a.

When the frequency channel specified by a base station is in, for example, the higher frequency channel group FTH in the transmission band and the higher frequency channel group FRH in the reception band shown in FIG. 5, the phase shift control function 12a outputs a switching control signal RC to insert the phase shifter 41 between the duplexer 2 and low noise amplifier 31. On the other hand, when the frequency channel specified by the base station is in the lower frequency channel group FTL in the transmission band and the lower frequency channel group FRL in the reception band shown in FIG. 5, the phase shift control function 12a outputs a switching control signal RC to bypass the phase shifter 41.

Next, the operation of a mobile communication terminal unit configured as described above will be explained.

When the frequency channel to be used is specified by a base station, the control section 12 negotiates with the base station to establish a radio communication link. At the same time, the control section 12 generates a switching control signal RC according to the specified frequency channel and supplies the switching control signal RC to the phase shift circuit 30A.

For example, when the specified frequency channel is in the higher frequency channel group FTH in the transmission band and the higher frequency channel group FRH in the reception band shown in FIG. 5, the control section 12 generates a switching control signal RC to set each of the switching circuits 42, 43 of the phase shift circuit 30A to the phase shifter 41 and outputs the switching control signal. For this reason, in the phase shift circuit 30A, the switching circuits 42, 43 are switched to the phase shifter 41 side, thereby inserting the phase shifter 41 between the duplexer 2 and low-noise amplifier 31.

Therefore, the characteristic of the phase of the output load of the duplexer 2 is set to the characteristic corresponding to P2 shown in FIG. 5, with the result that sufficient attenuation is assured for the higher frequency channel group FTH in the transmission band. This suppresses sufficiently the level of the transmitted wave leaking from the duplexer 2 into the receiving system during communication, preventing the cross modulation of the transmitted wave components and disturbance wave components, which keeps the reception sensitivity of the reception channels high.

On the other hand, for example, it is assumed that the mobile communication terminal moves to another cell and, as a result of this, the base station specifies the lower frequency channel group FTL in the transmission band and the lower frequency channel group FRL in the reception band shown in FIG. 5. Then, the control section 12 generates a switching control signal RC to switch each of the switching circuits 42, 43 of the phase shift circuit 30A to the bypass circuit and outputs the switching control signal RC. As a result, in the phase shift circuit 30A, the switching circuits 42, 43 are switched from the duplexer 41 to the bypass circuit, thereby connecting the duplexer 2 and low-noise amplifier 31 directly.

Therefore, the characteristic of the phase of the output load of the duplexer 2 is switch to the characteristic corresponding to P1 shown in FIG. 5. As a result, the insertion loss for the lower frequency channel group FRL in the reception band is suppressed to a small value, which helps keep the reception sensitivity high when the lower frequency channel group is used.

As described above, in the first embodiment, the phase shift circuit 30A composed of the phase shifter 41 and switching circuits 42, 43 is provided between the duplexer 2 and low-noise amplifier 31, and the control section 12 has the phase shift control function 12a. The phase shift control function 12a provides switching control of the switching circuits 42, 43 according to whether the frequency channel used in communication is in the higher frequency channel groups FTH and FRH or the lower frequency channel groups FTL and FRL in the transmission and reception bands. With the switching control, when the higher frequency channel groups FTH and FRH are used, the phase shifter 41 is inserted between the duplexer 2 and low-noise amplifier 31, whereas when the lower frequency channel groups FTL and FRL are used, the duplexer 2 and low-noise amplifier are connected directly to each other by the bypass circuit.

Consequently, when the higher frequency channel groups FTH and FRH are used, sufficient attenuation can be achieved for the higher frequency group FTH in the transmission band, which suppresses sufficiently the level of the transmitted wave leaking from the duplexer 2 into the receiving system during communication. As a result, the cross modulation of the transmitted wave components and disturbance wave components is prevented, which helps keep the reception sensitivity of the receiving channels high.

In contrast, when the lower frequency channel groups FTL and FRL are used, the insertion loss for the lower frequency channel group FRL in the reception band can be switch to a sufficiently small value, which helps keep the reception sensitivity of the lower frequency channel group FRL high.

Furthermore, in the first embodiment, by just controlling the insertion and removal of the phase shifter 41 according to the frequency channel to be used, the phase of the output load of the duplexer 2 can be switch to the optimum value. As a result, only one phase shifter 41 has to be provided, which leads to the advantage of making the circuit configuration simpler.

(Second Embodiment)

A second embodiment of the present invention is such that an impedance shift circuit composed of an impedance element 51 and a switch circuit 52 is provided between the duplexer and the low-noise amplifier of the receiving circuit and that an impedance shift control function is provided in the control section. The impedance shift control function controls the connection/disconnection of the impedance shift circuit between the duplexer and low-noise amplifier according to whether higher frequency channels or lower frequency channels in the transmission and reception bands are used as the frequency channels for communication.

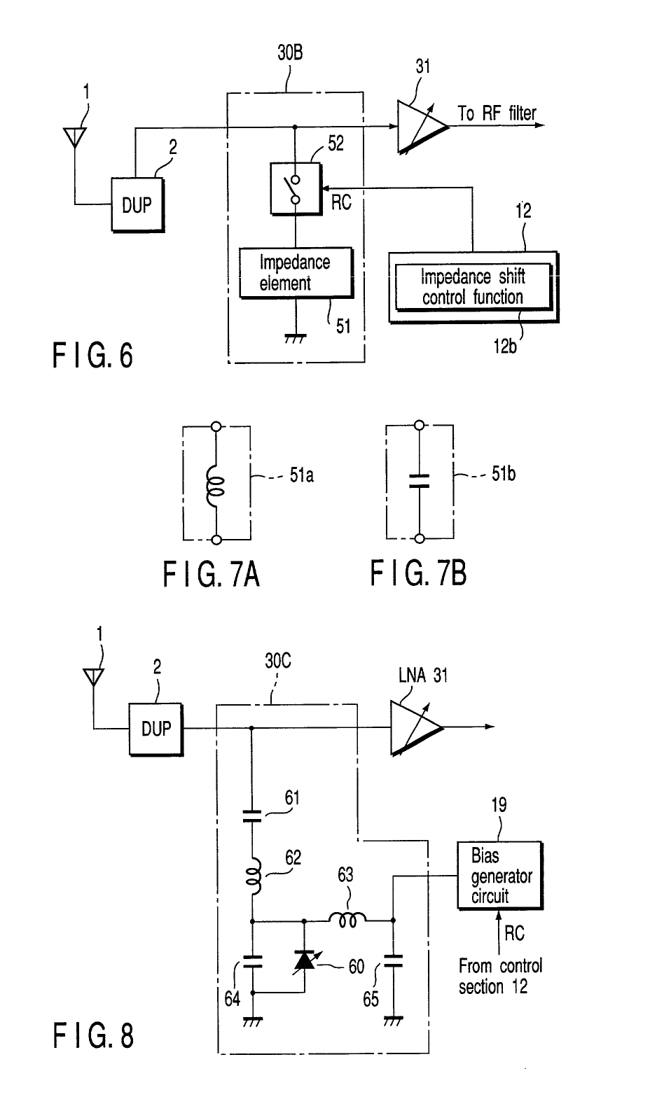

FIG. 6 is a circuit block diagram showing the configuration of the impedance shift circuit and control section, which are important parts of a mobile communication terminal according to the second embodiment. Since the remaining parts of the mobile communication terminal and receiving circuit have the same configuration as those of FIGS. 1 or 2, explanation of them will be omitted.

In FIG. 6, an impedance shift circuit 30B is provided between the duplexer 2 and low-noise amplifier 31. The impedance shift circuit 30B is such that a series circuit made up of an impedance element 51 and a switch circuit 52 is connected between a received signal path and an earth terminal. For the impedance element 51, for example, an inductor 51a or a capacitor 51b is used as shown in FIG. 7A and FIG. 7B, respectively. A semiconductor switch is used as the switch circuit 52.

The impedance element 51 shifts the output load impedance of the receiving filter in the duplexer 2 from a first value to a second value. The first value is set so that the frequency characteristic of the reception gain may be such that the insertion loss is suppressed to a sufficiently small value right across the reception band as shown by P1 in FIG. 5. The second value is set so that the frequency characteristic of the reception gain may be such that the gain is sufficiently attenuated right across the transmission band sufficiently as shown by P2 in FIG. 5.

The control section 12 has an impedance shift control function 12b. When the frequency channel specified by a base station is in, for example, the higher frequency channel group FTH in the transmission band and the higher frequency channel group FRH in the reception band shown in FIG. 5, the impedance shift control function 12b outputs a switching control signal RC to insert the impedance element 51 between the received signal path and the earth terminal. On the other hand, when the frequency channel specified by the base station is in the lower frequency channel group FTL in the transmission band and the lower frequency channel group FRL in the reception band shown in FIG. 5, the impedance shift control function 12b outputs a switching control signal RC to disconnect the impedance element 51 from between the received signal path and the earth terminal.

With this configuration, when the frequency channel to be used is specified by the base station, the control section 12 negotiates with the base station to establish a radio communication link. At the same time, the control section 12 generates a switching control signal RC according to the specified frequency channel and supplies the switching control signal RC to the impedance shift circuit 30B.

For example, when the specified frequency channel is in the higher frequency channel group FTH in the transmission band and the higher frequency channel group FRH in the reception band shown in FIG. 5, the control section 12 generates a switching control signal RC to turn on the switch circuit 52 of the impedance shift circuit 30B. As a result, in the impedance shift circuit 30B, the switch circuit 52 turns on, thereby inserting the impedance element 51 between the received signal path and the earth terminal.

Therefore, the characteristic of the impedance of the output load of the duplexer 2 is set to the characteristic corresponding to P2 shown in FIG. 5, with the result that sufficient attenuation is assured for the higher frequency channel group in the transmission band. This suppresses sufficiently the level of the transmitted wave leaking from the duplexer 2 into the receiving system during communication, preventing the cross modulation of the transmitted wave components and disturbance wave components, which keeps the reception sensitivity of the reception channels high.

On the other hand, for example, it is assumed that the mobile communication terminal moves to another cell and, as a result of this, the base station specifies the lower frequency channel group FTL in the transmission band and the lower frequency channel group FRL in the reception band shown in FIG. 5. Then, the control section 12 generates a switching control signal RC to turn off the switch circuit 52 of the impedance shift circuit 30B. As a result, in the impedance shift circuit 30B, the switch circuit 52 turns off, thereby disconnecting the impedance element 51 from the received signal path.

Therefore, the characteristic of the output load impedance of the duplexer 2 is set to the characteristic corresponding to P1 shown in FIG. 5. As a result, the insertion loss for the lower frequency channel group FRL in the reception band is suppressed to a small value, which helps keep the reception sensitivity high when the lower frequency channel group is used.

As described above, in the second embodiment as in the first embodiment, when the higher frequency channel groups FTH and FRH are used, sufficient attenuation can be achieved for the higher frequency channel group FTH in the transmission band, which suppresses sufficiently the level of the transmitted wave components leaking from the duplexer 2 into the receiving system during communication. As a result, the cross modulation of the transmitted wave components and disturbance wave components is prevented, which helps keep the reception sensitivity of the receiving channels high.

In contrast, when the lower frequency channel groups FTL and FRL are used, the insertion loss for the lower frequency channel group FRL in the reception band can be set to a sufficiently small value, which helps keep the reception sensitivity of the lower frequency channel group high.

Furthermore, by just turning on and off the connection of the impedance element 51 according to the frequency channel to be used, the output load impedance of the duplexer 2 can be set to the optimum value. As a result, only one impedance element 51 has to be provided, which leads to the advantage of making the circuit configuration simpler.

(Third Embodiment)

A third embodiment of the present invention is such that an impedance shift circuit using a variable-capacitance element (or variable capacitor) is provided between the duplexer and the low-noise amplifier and that an impedance shift control function is provided in the control section. The impedance shift control function generates a bias voltage (or control voltage) to provide variable control of the impedance of the variable capacitor according to whether higher frequency channels or lower frequency channels in the transmission and reception bands are used as the frequency channels for communication, and supplies the bias voltage to the impedance shift circuit.

FIG. 8 is a circuit block diagram showing the configuration of the impedance shift circuit and control section, which are important parts of a mobile communication terminal according to the third embodiment. In the third embodiment, since the remaining parts of the mobile communication terminal and receiving circuit have the same configuration as those of FIGS. 1 or 2, explanation of them will be omitted.

In FIG. 8, an impedance shift circuit 30C is provided between the duplexer 2 and low-noise amplifier 31. The impedance shift circuit 30C is composed of capacitors 61, 64, 65, inductors 62, 63, and a variable capacitor 60 connected as shown in FIG. 8. The impedance value of the impedance shift circuit 30C varies according to the value of the bias voltage supplied from a bias generator circuit 19.

The bias generator circuit 19 generates two types of control voltage according to a first and a second switching control signal RC generated by the control section 12 and supplies the control voltage to the impedance shift circuit 30C as the bias voltage to the variable capacitor.

With this configuration, when the frequency channel to be used is specified by the base station, the control section 12 negotiates with the base station to establish a radio communication link. At the same time, the control section 12 generates a switching control signal RC according to the specified frequency channel and supplies the switching control signal RC to the impedance shift circuit 30C.

For example, when the specified frequency channel is in the higher frequency channel group FTH in the transmission band and the higher frequency channel group FRH in the reception band shown in FIG. 5, the control section 12 generates a first control signal. Then, the bias generator circuit 19 generates a first control voltage and supplies the control voltage as a bias voltage to the variable capacitor 60 of the impedance shift circuit 30C. The supply of the first control voltage causes the impedance of the impedance shift circuit 30C to change to the value corresponding to the characteristic that assures sufficient attenuation right across the transmission band as shown by P2 in the frequency characteristic of reception gain of FIG. 5.

As a result, sufficient attenuation is assured for the higher frequency channel group FTH in the transmission band. This suppresses sufficiently the level of the transmitted wave leaking from the duplexer 2 into the receiving system during communication, preventing the cross modulation of the transmitted wave components and disturbance wave components, which keeps the reception sensitivity of the reception channels high.

On the other hand, for example, it is assumed that the mobile communication terminal moves to another cell and, as a result of this, the base station specifies the lower frequency channel group FTL in the transmission band and the lower frequency channel group FRL in the reception band shown in FIG. 5. In this case, the control section 12 generates a second control signal. Then, the bias generator circuit 19 generates a second control voltage and supplies the control voltage as a bias voltage to the variable capacitor 60 of the impedance shift circuit 30C. The supply of the second control voltage causes the impedance of the impedance shift circuit 30C to change to the value corresponding to the characteristic that reduces the insertion loss for the lower frequency channel group FRL in the reception band as shown by P1 in the frequency characteristic of reception gain of FIG. 5.

As a result, the insertion loss for the lower frequency channel group FRL in the reception band is suppressed to a small value, which helps keep the reception sensitivity high when the lower frequency channel group is used.

As described above, in the third embodiment as in the first and second embodiments, when the higher frequency channel groups FTH and FRH are used, sufficient attenuation can be achieved for the higher frequency group FTH in the transmission band, which suppresses sufficiently the level of the transmitted wave leaking from the duplexer 2 into the receiving system during communication. As a result, the cross modulation of the transmitted wave components and disturbance wave components is prevented, which helps keep the reception sensitivity of the receiving channels high.

In contrast, when the lower frequency channel groups FTL and FRL are used, the insertion loss for the lower frequency channel group FRL in the reception band can be set to a sufficiently small value, which helps keep the reception sensitivity of the lower frequency channel group FRL high.

Furthermore, use of the impedance shift circuit 30C using the variable capacitor 60 makes switching circuits and switch circuits unnecessary, which helps make the size of the circuit accordingly smaller.

(Fourth Embodiment)

While in the first to third embodiments, the reception band has been higher than the transmission band, the present invention may be applied to the case where the reception band is lower than the transmission band.

FIG. 9 shows a frequency characteristic in this case. When the frequency channel specified by a base station is in the higher frequency channel group FRH in the reception band and the higher frequency channel group FTH in the transmission band, control is performed in such a way that the frequency characteristic of the gain of the input to the low-noise amplifier 31 is as shown by P3 in FIG. 9. For example, in the phase shift circuit 30A of FIG. 3, the amount of phase shift is controlled in such a way that the frequency characteristic of the gain of the input to the low-noise amplifier 31 is as shown by P3 in FIG. 9. Furthermore, in the impedance shift circuit 30B of FIG. 6 or 30C of FIG. 8, the impedance is controlled in such a way that the frequency characteristic of the gain of the input to the low-noise amplifier 31 is as shown by P3 in FIG. 9.

On the other hand, when the frequency channel specified by the base station is in the lower frequency channel group FRL in the reception band and the higher frequency channel group FTL in the transmission band, control is performed in such a way that the frequency characteristic of the gain of the input to the low-noise amplifier 31 is as shown by P4 in FIG. 9. For example, in the phase shift circuit 30A of FIG. 3, the amount of phase shift is controlled in such a way that the frequency characteristic of the gain of the input to the low-noise amplifier 31 is as shown by P4 in FIG. 9. Furthermore, in the impedance shift circuit 30B of FIG. 6 or 30C of FIG. 8, the impedance is controlled in such a way that the frequency characteristic of the gain of the input to the low-noise amplifier 31 is as shown by P4 in FIG. 9.

With this configuration, when the lower frequency channel groups FTL and FRL are used, sufficient attenuation can be achieved for the lower frequency group FTL in the transmission band, which suppresses sufficiently the level of the transmitted wave leaking from the duplexer 2 into the receiving system during communication. As a result, the cross modulation of the transmitted wave components and disturbance wave components is prevented, which helps keep the reception sensitivity of the receiving channels high.

In contrast, when the higher frequency channel groups FTH and FRH are used, the insertion loss for the higher frequency channel group FRH in the reception band can be set to a sufficiently small value, which helps keep the reception sensitivity of the lower frequency channel group high.

(Other Embodiments)

In the first embodiment, the phase shift circuit 30A has been composed of the phase shifter 41 and switching circuits 42, 43. The phase shifter has been inserted and removed from between the duplexer 2 and low-noise amplifier 31 by switching between the switching circuits 42, 43.

The present invention is not limited to this phase shift circuit 30A. For instance, the phase shift circuit 30A may be composed of a first phase setting circuit that sets the output load phase of the duplexer to a first value, a second phase setting circuit that sets the output load phase of the duplexer to a second value, and a switching circuit that selectively inserts either the first or second phase setting circuit in between the duplexer and the receiving system. The phase shift control function of the control section provides switching control of the switching circuit according to the selected frequency channel pair, thereby selectively inserting either the first or second phase setting circuit between the duplexer and the receiving circuit.

With this configuration, when a higher frequency channel is used and when a lower frequency channel is used, the optimum characteristic can be set in each of these cases.

Furthermore, the impedance shift circuit may be composed of a first impedance setting circuit that sets the output load impedance of the duplexer to a first value, a second phase setting circuit that sets the output load impedance of the duplexer to a second value, and a switching circuit. An impedance shift control means provides switching control of the switching circuit according to the selected frequency channel pair, thereby selectively connecting either the first or second impedance setting circuit between the duplexer and the receiving circuit.

In this case, too, when a higher frequency channel is used and when a lower frequency channel is used, the optimum characteristic can be set in each of these cases.

In addition, the type and configuration of a radio communication apparatus, the circuit configuration of a radio receiving circuit, and the circuit configuration of a phase shift circuit and an impedance shift circuit may be embodied in still other ways without departing from the spirit or essential character of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radio communication apparatus comprising:
an antenna;
duplexer means for connecting said antenna with transmitting means and receiving means in such a manner that the transmitting means and the receiving means share said antenna;
phase varying means which is provided between said duplexer means and said receiving means and varies a phase of a output load of said duplexer means; and
phase variation control means for controlling said phase varying means according to a frequency channel pair selected from a plurality of frequency channel pairs assigned in a transmission band and reception band to change the phase of the output load of said duplexer means to a value corresponding to the selected frequency channel pair.

2. The radio communication apparatus according to claim 1, wherein
said phase varying means includes
first phase setting means for setting the phase of the output load of said duplexer means to a first value;
second phase setting means for setting the phase of the output load of said duplexer means to a second value; and
switching means for selectively inserting the first or second phase setting means in between said duplexer means and said receiving means, and
said phase variation control means includes
means for controlling said switching means according to the selected frequency channel pair to selectively insert said first or second phase setting means in between said duplexer means and said receiving means.

3. The radio communication apparatus according to claim 1, wherein
said phase varying means includes
phase shift means for setting the phase of the output load of said duplexer means to a first value;
bypass means for bypassing said phase shift means to connects said duplexer means directly to said receiving means to sets the phase of the output load of said duplexer means to a second value; and
switching means for selectively connecting said phase shift means or said bypass means between said duplexer means and said receiving means, and
said phase variation control means includes
means for controlling said switching means according to the selected frequency channel pair to selectively connect said phase shift means or bypass means between said duplexer means and said receiving means.

4. A radio communication apparatus comprising:
an antenna;
duplexer means for connecting said antenna with transmitting means and receiving means in such a manner that the transmitting means and receiving means share said antenna;
impedance varying means which is provided between said duplexer means and said receiving means and varies an impedance of an output load of said duplexer means; and
impedance variation control means for controlling said impedance varying means according to a frequency channel pair selected from a plurality of frequency channel pairs assigned in a transmission band and reception band to change the impedance of the output load of said duplexer means to a value corresponding to the selected frequency channel pair.

5. The radio communication apparatus according to claim 4, wherein
said impedance varying means includes
first impedance setting means for setting the impedance of the output load of said duplexer means to a first value;
second impedance setting means for setting the impedance of the output load of said duplexer means to a second value; and
switching means for selectively connecting the first or second impedance setting means between said duplexer means and said receiving means, and
said impedance variation control means includes
means for controlling said switching means according to the selected frequency channel pair to selectively connect said first or second impedance setting means between said duplexer means and said receiving means.

6. The radio communication apparatus according to claim 4, wherein
said impedance varying means includes
third impedance setting means for setting the impedance of the output load of said duplexer means to a third value; and
switching means for switching the connection of said third impedance setting means to said duplexer means, and
said impedance variation control means includes
means for controlling said switching means according to the selected frequency channel pair to determine whether said third impedance setting means should be connected to said duplexer means.

7. The radio communication apparatus according to claim 4, wherein said impedance varying means is composed of a circuit with a variable impedance element, and
said impedance variation control means generates a control bias voltage according to the selected frequency channel pair and applies the bias voltage to the variable impedance element, thereby variably setting the impedance of the output load of said duplexer means to a value corresponding to the selected frequency channel pair.

8. A radio communication apparatus comprising:
an antenna;
a duplexer configured to connects said antenna with a transmitting circuit and a receiving circuit in such a manner that the transmitting circuit and the receiving circuit share said antenna;
a phase varying circuit configured to is provided between said duplexer and said receiving circuit and varies a phase of a output load of said duplexer; and
a phase variation control circuit configured to controls said phase varying circuit according to a frequency channel pair selected from a plurality of frequency channel pairs assigned in a transmission band and reception band to change the phase of the output load of said duplexer to a value corresponding to said selected frequency channel pair.

9. The radio communication apparatus according to claim 8, wherein
said phase varying circuit includes
a first phase setting circuit configured to sets the phase of the output load of said duplexer to a first value;
a second phase setting circuit configured to sets the phase of the output load of said duplexer to a second value; and
a switching circuit configured to selectively inserts the first or second phase setting circuits in between said duplexer and said receiving circuit, and
said phase variation control circuit controls said switching circuit according to the selected frequency channel pair to selectively insert said first or second phase setting circuits in between said duplexer and said receiving circuit.

10. The radio communication apparatus according to claim 8, wherein
said phase varying circuit includes
a phase shift circuit configured to sets the phase of the output load of said duplexer to a first value;
a bypass circuit configured to bypass said phase shift circuit to connects said duplexer directly to said receiving circuit to sets the phase of the output load of said duplexer to a second value; and
a switching circuit configured to selectively connects said phase shift circuit or said bypass circuit between said duplexer and said receiving circuit, and
said phase variation control circuit controls said switching circuit according to the selected frequency channel pair to selectively connect said phase shift circuit or bypass circuit between said duplexer and said receiving circuit.

11. A radio communication apparatus comprising:
an antenna;
a duplexer configured to connects said antenna with a transmitting circuit and a receiving circuit in such a manner that the transmitting circuit and receiving circuit share said antenna;
an impedance varying circuit configured to is provided between said duplexer and said receiving circuit and varies an impedance of an output load of said duplexer; and
an impedance variation control circuit configured to controls said impedance varying circuit according to a frequency channel pair selected from a plurality of frequency channel pairs assigned in a transmission band and reception band to change the impedance of the output load of said duplexer to a value corresponding to the selected frequency channel pair.

12. A radio communication apparatus according to claim 11, wherein
said impedance varying circuit includes
a first impedance setting circuit configured to sets the impedance of the output load of said duplexer to a first value;
a second impedance setting circuit configured to sets the impedance of the output load of said duplexer to a second value; and
a switching circuit configured to selectively connects the first or second impedance setting circuit between said duplexer and said receiving circuit, and
said impedance variation control circuit controls said switching circuit according to the selected frequency channel pair to selectively connect said first or second impedance setting circuits between said duplexer and said receiving circuit.

13. The radio communication apparatus according to claim 11, wherein
said impedance varying circuit includes
a third impedance setting circuit configured to sets the impedance of the output load of said duplexer to a third value; and
a switching circuit configured to switches the connection of said third impedance setting circuit to said duplexer, and
said impedance variation control circuit controls said switching circuit according to the selected frequency channel pair to determine whether said third impedance setting circuit should be connected to said duplexer.

14. The radio communication apparatus according to claim 11, wherein said impedance varying circuit includes a variable impedance element, and
said impedance variation control circuit generates a control bias voltage according to the selected frequency channel pair and applies the bias voltage to said variable impedance element, thereby variably setting the impedance of the output load of said duplexer to a value corresponding to the selected frequency channel pair.
